(19) United States
(12) Patent Application Publication
(10) Pub. No.: US 2024/0270887 A1
(43) Pub. Date: Aug. 15, 2024

(54) LOW ENERGY NANOEMULSION POLYMERIZATION WITH LOW LEVELS OF SURFACTANTS

(71) Applicant: BASF SE, Ludwigshafen am Rhein (DE)

(72) Inventors: Matthew LYON, Wyandotte, MI (US); Sean GEORGE, Wyandotte, MI (US); Christopher SICHMELLER, Wyandotte, MI (US)

(21) Appl. No.: 18/577,067

(22) PCT Filed: Jul. 29, 2022
(86) PCT No.: PCT/EP22/71301

§ 371 Date: Jan. 5, 2024

Related U.S. Application Data
(60) Provisional application No. 63/227,488, filed on Jul. 30, 2021.

(30) Foreign Application Priority Data
Nov. 18, 2021 (EP) 21208980.9

(51) Int. Cl. C08F 220/18; C08F 2/26

(52) U.S. Cl. CPC C08F 220/1812; C08F 2/26

(57) ABSTRACT

Disclosed herein are a low energy process for preparing a nanoemulsion and a process of preparing a polymer from that nanoemulsion. Further disclosed herein is an aqueous nanoemulsion prepared by the process.

### TECHNICAL FIELD

The present invention relates to a low energy process for preparing a nanoemulsion. The present invention further relates to a process of preparing a polymer from the said nanoemulsion. The present invention is also directed to an aqueous nanoemulsion prepared by the process of the presently claimed invention.

### BACKGROUND OF THE INVENTION

Miniemulsion polymerization is a method of emulsion polymerization where a monomer emulsion is reduced to a size in the range of 50 to 1000 nm, and subsequently polymerized. It allows the use of hydrophobic monomers that do not polymerize in traditional emulsion polymerization systems. Additionally, additives like nanoparticles and unreactive waxes/oils can be incorporated into the final latex. The processes disclosed in the prior art, however, require either use of large quantities of surfactants (more than 20%, by weight of the total weight of monomer) or use of high energy such as homogenization or sonication.

Due to the high energy needed to create these nanoemulsions, these processes have not been commercially successful due to issues with high energy emulsification upon scaling up, or the inability to use existing infrastructure.

It is an objective of the present invention to have a process of preparing a nanoemulsion which is not only a low energy process, but also uses a low amount of surfactant and which fits within existing traditional emulsion polymerization equipment and does not require special equipment. Another objective of the present invention is to have a process for preparing polymer from the nanoemulsion, which is applicable to hydrophobic monomers as well.

### SUMMARY OF THE INVENTION

Surprisingly, it has been found that by utilizing the principles of hydrophilic-lipophilic deviation (HLD), a process for nanoemulsification under standard agitation, i.e. at low energy and low surfactant loading (1-10 wt. % based on the weight of the monomer) can be achieved.

Accordingly, in one aspect, the present invention is directed to a process for preparing a nanoemulsion comprising the steps of:
(i) forming an emulsion system having a hydrophilic-lipophilic deviation (HLD) value in the range of 0 to −1 at a temperature of 0° C. to 100° C., wherein said emulsion system comprises at least one monomer, at least one surfactant, a salt and water,
(ii) increasing the internal phase of said emulsion system to up to 80% by volume of the emulsion system by adding an additional amount of the at least one monomer used in step (i) or at least one monomer different than used in step (i) to said emulsion system, and
(iii) mixing the contents of step (ii) at a temperature of 0° C. to 100° C. to obtain a nanoemulsion having a volume average particle size in the range of 50 nm to 1000 nm determined according to dynamic light scattering technique.

Another aspect of the presently claimed invention is directed to an aqueous nanoemulsion prepared by the process as mentioned above.

In an aspect the presently claimed invention is directed to a process for preparing a polymer from the nanoemulsion prepared by the process as described herein above.

### DETAILED DESCRIPTION

Before the present compositions, concentrates and formulations of the invention are described, it is to be understood that this invention is not limited to particular compositions, concentrates and formulations described, since such compositions, concentrates and formulation may, of course, vary. It is also to be understood that the terminology used herein is not intended to be limiting, since the scope of the present invention will be limited only by the appended claims.

If hereinafter a group is defined to comprise at least a certain number of embodiments, this is meant to also encompass a group which preferably consists of these embodiments only. Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. In case the terms “first”, “second”, “third” or “(A)”, “(B)” and “(C)” or “(a)”, “(b)”, “(c)”, “(d)”, “i”, “ii” etc. relate to steps of a method or use or assay there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment but may be referred to be so.

Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the invention, and form different embodiments, as would be understood by those in the art. For example, in the appended claims, any of the claimed embodiments can be used in any combination.

Further, it shall be noted that the terms “at least one”, “one or more” or similar expressions indicating that a feature or element may be present once or more than once typically will be used only once when introducing the respective feature or element. In the following, in most cases, when referring to the respective feature or element, the expressions “at least one” or “one or more” will not be repeated, notwithstanding the fact that the respective feature or element may be present once or more than once.

Furthermore, the ranges defined throughout the specification include the end values as well, i.e. a range of 1 to 10, between 1 to 10 imply that both 1 and 10 are included in the range. For the avoidance of doubt, the applicant shall be entitled to any equivalents according to applicable law.

An aspect of the present invention is directed to a process for preparing a nanoemulsion comprising the steps of:
(i) forming an emulsion system having a hydrophilic-lipophilic deviation (HLD) value in the range of 0 to −1 at a temperature of 0° C. to 100° C., wherein said emulsion system comprises at least one monomer, at least one surfactant, a salt and water,
(ii) increasing the internal phase of said emulsion system to up to 80% by volume of the emulsion system by adding an additional amount of the at least one monomer used in step (i) or at least one monomer different than used in step (i) to said emulsion system, and
(iii) mixing the contents of step (ii) at a temperature of 0° C. to 100° C. to obtain a nanoemulsion having a volume average particle size in the range of 50 nm to 1000 nm determined according to dynamic light scattering technique.

Another aspect of the presently claimed invention is directed to an aqueous nanoemulsion prepared by the process as mentioned above.

In an aspect the presently claimed invention is directed to a process for preparing a polymer from the nanoemulsion prepared by the process as described herein above.

A nanoemulsion is an emulsion that is kinetically stable having average particle size less than 1000 nm. The nanoemulsion is thermodynamically unstable.

A miniemulsion is a nanoemulsion prepared by high energy process e.g. sonification or homogenization prior to polymerization.

The terms nanoemulsion and miniemulsion may be used interchangeably and imply the same meaning throughout the present invention.

### Monomers

In an embodiment, the at least one monomer is a hydrophobic monomer. Hydrophobic monomers are materials that are not soluble in water or other polar solvents.

In an embodiment, the hydrophobic monomer is α,β-ethylenically unsaturated monomer.

In an embodiment, the at least one monomer is selected from methyl acrylate, methyl methacrylate, ethyl acrylate, ethyl methacrylate, n-butyl acrylate, butyl methacrylate, 2-ethylhexyl acrylate, 2-ethylhexyl methacrylate, isobutyl (meth)acrylate, n-hexyl (meth)acrylate, n-heptyl (meth)acrylate, 2-methylheptyl (meth)acrylate, octyl (meth)acrylate, isooctyl (meth)acrylate, n-nonyl (meth)acrylate, isononyl (meth)acrylate, n-decyl (meth)acrylate, isodecyl (meth)acrylate, dodecyl (meth)acrylate, lauryl acrylate, lauryl (meth)acrylate, tridecyl (meth)acrylate, stearyl acrylate, stearyl (meth)acrylate, glycidyl (meth)acrylate, alkyl crotonate, di-n-butyl maleate, di-octylmaleate, hydroxyethyl (meth)acrylate, allyl (meth)acrylate, tetrahydrofurfuryl (meth)acrylate, cyclohexyl (meth)acrylate, 2-ethoxyethyl (meth)acrylate, 2-methoxy (meth)acrylate, 2 (2 ethoxyethoxy)ethyl (meth)acrylate, 2-propylheptyl (meth)acrylate, 2-phenoxyethyl (meth)acrylate, isobornyl (meth)acrylate, caprolactone (meth)acrylate, polypropyleneglycol mono(meth)acrylate, polyethyleneglycol (meth)acrylate, benzyl (meth)acrylate, hydroxypropyl (meth)acrylate, methylpolyglycol (meth)acrylate, 3,4-epoxycyclohexylmethyl (meth)acrylate, 1,6 hexanediol di(meth)acrylate, 1,4-butanediol di(meth)acrylate, styrene, butadiene, vinyl ester, acrylonitrile, (meth)acrylamide, 2-ethylhexyl thioglycolate, 3,5,5-trimethyl-1-hexyl acrylate, 3-butyl mercaptopropionate, acetoacetoxyethyl methacrylate, alpha methylstyrene, C₁₇-acrylate, diacetone acrylamide, dimethylaminoethyl acrylate, isoamyl acrylate, isobutyl acrylate, isodecyl acrylate, isononyl acrylate, isoprenol acrylate, prenol acrylate, tert-butyl acrylate, tert-butyl methacrylate, vinyl acetate or combinations thereof.

In another embodiment, the at least one acid monomer is selected from α,β-ethylenically unsaturated acids. Examples of suitable ethylenically unsaturated acids include, but are not limited to, acrylic acid, methacrylic acid, itaconic acid, crotonic acid, maleic acid, fumaric acid, dimethacrylic acid, ethylacrylic acid, allylacetic acid, vinylacetic acid, vinyllactic acid, mesaconic acid, methylenemalonic acid, citraconic acid, vinyl-sulfonic acids, styrenesulfonic acids, acrylamido methylpropanesulfonic acid, sulfopropyl acrylate, sulfopropyl methacrylate, (meth)acrylic phosphate esters, or combinations thereof. The acid groups may be neutralized partly or completely with suitable bases such as aqueous sodium or potassium hydroxide solution or ammonia as a neutralizing agent.

In a preferred embodiment, the monomer is methyl methacrylate, lauryl acrylate, stearyl acrylate, lauryl acrylate, 2-ethylhexylacrylate, 1,4-butanediol diacrylate, 1,6-hexandediol diacrylate, 2-ethylhexyl thioglycolate, 2-propylheptyl methacrylate, 3,5,5-trimethyl-1-hexyl acrylate, 3-butyl mercaptopropionate, acetoacetoxyethyl methacrylate, acrylic acid, alpha methylstyrene, methacrylic acid, butyl methacrylate, C₁₇-acrylate, cyclohexyl methacrylate, diacetone acrylamide, dimethylaminoethyl acrylate, ethyl acrylate, glycidyl methacrylate, hydroxyethyl acrylate, hydroxyethyl methacrylate, hydroxypropyl acrylate, isoamyl acrylate, isobornyl methacrylate, isobutyl acrylate, isobutyl methacrylate, isodecyl acrylate, isononyl acrylate, isoprenol acrylate, lauryl acrylate, prenol acrylate, stearyl acrylate, styrene, tert-butyl acrylate, tert-butyl methacrylate, vinyl acetate, or combinations thereof.

In an embodiment, the volume % of the at least one monomer is 20% to 80% by volume.

### Surfactant

The process according to the present invention comprises at least one surfactant.

In an embodiment. the at least one surfactant is selected from cationic surfactant, anionic surfactant, zwitterionic surfactant, non-ionic surfactant, and combinations thereof.

In an embodiment an anionic surfactant has the following structure

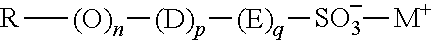

wherein
R is a linear or branched, substituted or unsubstituted C₆-C₂₂ alkyl or substituted or unsubstituted C₆-C₂₀ alkyl aryl
D denotes CH(CH₃)—CH₂—O—,
E denotes CH₂—CH₂—O—
n is an integer in the range from 0 to 1,
p is an integer in the range from 0 to 10,
q is an integer in the range from 0 to 20, and
M is H or an alkali metal or ammonium cation.

In a preferred embodiment, R is linear or branched, unsubstituted C₆-C₂₀ alkyl.

In a more embodiment, R is linear or branched, unsubstituted C₈-C₂₀ alkyl.

In a most preferred embodiment, R is linear, unsubstituted C₈-C₁₈ alkyl.

In another embodiment, R is linear or branched substituted or unsubstituted C₆-C₂₀ alkyl aryl.

In a preferred embodiment, R is linear or branched substituted or unsubstituted C₁₀-C₁₃ alkyl benzene.

In a most preferred embodiment, R is linear C₁₀-C₁₃ alkyl benzene.

In a preferred embodiment, the cation M is selected from H, sodium, potassium or ammonium cation.

The anionic surfactant of the embodiment, p=0, q=0, R is linear or branched, unsubstituted C₈-C₁₂ alkyl, M=sodium, are obtained by sulfating the alcohols (C₈-C₁₂ carbon atoms) produced from the glycerides of tallow, coconut oil, suitable vegetable oil or synthetic alcohols followed by neutralization with alkali hydroxide. Thus, the resulting compounds also contain reaction by-products such as free salt (for example sodium chloride is the free salt by product, when neutralization agent is sodium hydroxide), free fatty alcohol, salt of fatty alcohol. Therefore, the solid content of the anionic surfactant may be different from the active content. Active content denotes “the amount of the anionic surfactant” present in the composition whereas the solid content denotes “a total of compound of anionic surfactant, fatty alcohol, salt of fatty alcohol and the free salt” in the composition. ‘Free’ herein denotes that the salt is not bound to the fatty alcohol/anionic surfactant of formula as given above by any kind of chemical bonding.

The anionic surfactant wherein p=0, q=1-20, R is linear or branched, unsubstituted C₆-C₂₂ alkyl, is produced by the ethoxylation of fatty alcohol and thus will generally be obtained in the form of mixtures comprising varying alkyl chain lengths and varying degrees of ethoxylation. Frequently such mixtures will inevitably also contain some non-ethoxylated alkyl sulfates.

In a preferred embodiment, p is an integer in the range of 2 to 10, more preferably in the range of 3 to 8, q is an integer in the range of 0.01 to 10, more preferably in the range of 0.05 to 8, R is linear or branched, unsubstituted C₁₄-C₁₈ alkyl, M=sodium or H.

Anionic surfactant of the preferred embodiment where p is an integer in the range of 2 to 10, q is an integer in the range of 0.01 to 10, R is linear or branched, unsubstituted C₁₄-C₁₈ alkyl, M is H, are produced by the propoxylation and ethoxylation of fatty alcohol, followed by sulfating the alcohols and thus will generally be obtained in the form of mixtures comprising varying alkyl chain lengths and varying degrees of propoxylation and ethoxylation. Frequently such mixtures may also contain some non-ethoxylated/non-propoxylated compounds. The neutralization of these propoxylated and ethoxylated sulfate compounds with alkali hydroxide such as sodium hydroxide leads to the compounds with M=sodium.

In a preferred embodiment, n is 0, p is 0, q is 0, R is linear or branched unsubstituted or substituted C₁₀-C₁₃ alkyl aryl, M=sodium.

α-Olefin sulphonates are generally produced by sulphonating α-olefin. The α-olefins, which are sulphonated to form the surfactants used in the compositions of the presently claimed invention, may contain from about 10 to 22 carbon atoms and preferably 12 to 18 carbon atoms. They may be derived from a variety of processes such as, for example, by wax cracking, ethylene built up or dehydration of the corresponding primary alcohol. Exemplary α-olefins are 1-decene, 1-undecene, 1-dodecene, 1-tridecene, 1-tetradecene, 1-pentadecene, 1-hexadecene, 1-heptadecene, 1-octadecene and the like and mixtures of the aforesaid. Sulphonation of these long chain olefins is typically carried out utilizing sulfur trioxide mixed with a diluent. After the sulphonation is completed, neutralization and hydrolysis of the acid mixture is carried out so that any by-product sulfones which are formed are converted to the corresponding hydroxyalkane sulphonates. Thus, as is well known in the art, the term α-olefin sulphonates as used herein includes not only the alkene sulphonate itself but also admixtures of the same that are formed as a result of the usual sulphonation neutralization, and hydrolysis procedure with substantial proportions of the corresponding water soluble hydroxyalkane sulphonates.

Linear alkyl benzene sulphonate (LABS) is produced by sulphonation of linear alkylbenzene (LAB) and subsequent neutralization of the corresponding sulphonic acid (HLAS). Linear alkylbenzene is synthesized by the alkylation of benzene with linear olefins. Traditional processes for alkylation of aromatics compounds use Friedel-Craft type catalysts, for example, hydrofluoric acid, aluminum trichloride and the like.

Anionic surfactant may also include alkylamide sulphates of formula

R″CONHR″′OSO₃M

wherein
R″ denotes a C₂-C₂₂ alkyl,
R″′ C₂-C₃ alkyl radical, and
M is a hydrogen atom or an alkali metal cation or ethoxylated (EO) and/or propoxylated (PO) derivatives thereof, containing on average from 0.5 to 60 EO and/or PO units.

Further anionic surfactants are, salts of C₈-C₂₄, saturated or unsaturated fatty acids, alkylglyceryl sulphonates, paraffin sulphonates, N-acyl N-alkyl taurates, alkylphosphates, isethionates, alkylsuccinamates, alkyl sulfosuccinates, sulfosuccinate monoesters or diesters, N-acyl sarcosinates, alkylglycoside sulphates, polyethoxycarboxylates, the cation being an alkali metal (sodium, potassium or lithium), a substituted or unsubstituted ammonium residue (methyl-, dimethyl-, trimethyl- or tetramethylammonium, dimethylpiperidinium, etc.) or an alkanolamine derivative (monoethanolamine, diethanolamine, triethanolamine, etc.) and alkyl or alkylaryl phosphate esters.

Sulfosuccinate ester has the following structure

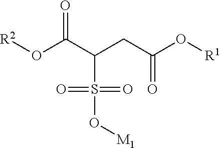

wherein
R¹ is a linear or branched, substituted or unsubstituted C₄ to C₂₂ alkyl,
R² is selected from H or a linear or branched, substituted or unsubstituted C₄ to C₂₂ alkyl, and
M₁ is H or an alkali metal cation.

In a preferred embodiment, R¹ and R² are independently linear, unsubstituted C₆ to C₂₀ alkyl.

In a more preferred embodiment, R¹ and R² are independently linear, unsubstituted C₆ to C₁₆ alkyl.

In a most preferred embodiment, R¹ and R² are identical and are linear, unsubstituted C₆ to C₁₂ alkyl.

In a preferred embodiment, the cation M₁ is selected from H, sodium, potassium or ammonium cation.

In a more preferred embodiment, the cation M₁ is selected from sodium or potassium cation.

In a most preferred embodiment, M₁ is sodium.

In a preferred embodiment, the sulfosuccinate ester is dissolved in water.

In another preferred embodiment, the sulfosuccinate ester is dissolved in a mixture of water and water miscible solvents.

In an embodiment, the water miscible solvents are selected from ethylene glycol, propylene glycol, neopentyl glycol or mixtures thereof.

In a preferred embodiment, the sulfosuccinate ester is dissolved in a mixture of water & neopentyl glycol.

Cationic surfactants are a well-known group of surface-active compounds which have at least one active cationic (positive ion) constituent. As the cationic surfactant, quaternary ammonium hydroxides such as octyltrimethylammonium hydroxide, dodecyltrimethylammonium hydroxide, hexadecyltrimethylammonium hydroxide, octyldimethylbenzylammonium hydroxide, decyldimethylbenzylammonium hydroxide, didodecyldimethylammonium hydroxide, dioctadecyldimethylammonium hydroxide, beef tallow trimethylammonium hydroxide, and coconut oil trimethylammonium hydroxide, and their salts can be exemplified.

Examples of amphoteric surfactants comprise betaines, sulphobetaines and carboxylates and sulphonates of fatty acids and of imidazole, such as alkyldimethylbetaines, alkylamidopropyldimethylbetaines, alkyldimethylsulphobetaines or alkylamidopropyldimethylsulphobetaines.

Among the nonionic surfactants which may be mentioned in are condensates of alkylene oxide, in particular of ethylene oxide, with alcohols, polyols, alkylphenols, fatty acid esters, fatty acid amides and fatty amines; oxide amines, sugar derivatives such as polyalkylglycosides or fatty acid esters of sugars, in particular sucrose monopalmitate; long-chain tertiary phosphine oxides; dialkyl sulphoxides; block copolymers of polyoxyethylene and of polyoxypropylene; polyalkoxylated sorbitan esters; fatty esters of sorbitan, poly(ethylene oxide) and fatty acid amides modified so as to give them a hydrophobic nature (for example fatty acid mono- and diethanolamides containing from 10 to 18 carbon atoms). Particularly, polyoxyalkylated (polyethoxyethylated, polyoxypropylated or polyoxybutylated) alkylphenols in which the alkyl substituent is C₆-C₁₂ and containing from 5 to 25 oxyalkylene units, glucosamides, glucamides and glycerolamides; polyoxyalkylated C₈-C₂₂ aliphatic alcohols containing from 1 to 25 oxyalkylene (oxyethylene, oxypropylene) units.

The above-mentioned surfactants can be used either alone or in combination as long as they're properly tuned in the emulsion to an HLD value in the range of 0 to −1.

In an embodiment, the amount of the at least one surfactant is in the range of 1 to 10% by weight, based on the total weight of the monomer.

In an embodiment, the characteristic curvature value (Cc) of the at least one surfactant is in the range of −10 to 10, calculated as molar-based average of each individual surfactant.

The characteristic curvature value Cc of a mixture of surfactants is the mole weighted average of the Ccs of the surfactants.

Characteristic curvature is a value assigned to a surfactant to judge its relative hydrophobicity or hydrophilicity in relation to other surfactants in the same family. By having this value, the performance of surfactant can be predicted by using the HLD equation.

The characteristic curvature is commonly measured through the HLD tube scan. A known amount of the surfactant to be measured is placed in several tubes. At a constant temperature, an oil with a known equivalent alkane carbon number (EACN) is added and an equal amount of saline solution is also added. The amount of salt is increased throughout the tubes changing the HLD value in each tube. Finding a Windsor type III microemulsion is evidence of HLD 0 at that salt concentration. The HLD is set to 0, and salt temperature and oil are then known, and the Cc value can be solved.

### Salt

The process according to the present invention comprises salt.

In an embodiment, the salt is selected from sodium chloride, potassium chloride, sodium hydroxymethanesulfinate hydrate, tetrasodium pyrophosphate.

In an embodiment, the amount of salt in the emulsion system is in the range of 0.1 to 15% by weight, based on the total weight of the monomer.

In an embodiment, the amount of salt in the emulsion system is in the range of 0.1 to 15% by weight, based on the total weight of the monomer.

In another embodiment, the amount of salt in the emulsion system is in the range of 0.1 to 10% by weight, based on the total weight of the monomer.

In yet another embodiment, the amount of salt in the emulsion system is in the range of 0.1 to 5% by weight, based on the total weight of the monomer.

### Water

In an embodiment, the volume % of water is 20% to 80% by volume.

The total amount of water in the process includes the water present in the surfactants and in the salt solution.

### Additional Component

In an embodiment, the process comprises an additional component

In an embodiment, the additional component is selected from oil, oil soluble compound or alcohol.

Preferably, the additional component is oil or oil soluble compound.

Examples of oil or oil soluble compounds are, but not restricted to hydrocarbons with more than 16 carbon atoms such as hexadecane, cetyl alcohol, polymethyl methacrylate, polystyrene, polyvinyl acetate, vinyl hexanoate, p-methyl styrene, vinyl 2-ethyl hexanoate, vinyl decanoate, vinyl stearate and mixtures thereof

### Process

In an embodiment, the present invention discloses a process for preparing a nanoemulsion comprises the steps of:
(i) forming an emulsion system having a hydrophilic-lipophilic deviation (HLD) value in the range of 0 to −1 at a temperature of 0° C. to 100° C., wherein said emulsion system comprises at least one monomer, at least one surfactant, a salt and water,
(ii) increasing the internal phase of said emulsion system to up to 80% by volume by adding an additional amount of the at least one monomer used in step (i) or at least one monomer different than used in step (i) to said emulsion system, and (iii) mixing the contents of step (ii) at a temperature of 0° C. to 100° C. to obtain a nanoemulsion having a volume average particle size in the range of 50 nm to 1000 nm determined according to dynamic light scattering technique.

In an embodiment, an emulsion system having a hydrophilic-lipophilic deviation (HLD) value in the range of 0 to −0.8 is formed at a temperature of 0° C. to 100° C.

In another embodiment, an emulsion system having a hydrophilic-lipophilic deviation (HLD) value in the range of 0 to −0.6 is formed at a temperature of 0° C. to 100° C.

In another embodiment, an emulsion system having a hydrophilic-lipophilic deviation (HLD) value in the range of 0 to −0.4 is formed at a temperature of 0° C. to 100° C.

Hydrophilic-lipophilic deviation (HLD) is an empirical model that predicts surfactant performance based on the salinity, temperature, oil, and surfactant in a system. Due to the process of the present invention, the emulsion system is balanced where all of the surfactant is attracted, and therefore located at the interface. At this point the interfacial tension is quite low.

Quickly moving away from this point by adjusting the HLD parameters is called “quenching.” This is done by changing the salinity, temperature, oil and surfactant. As a result, the surfactant remains at the interface yielding a nanoemulsion of a certain size, depending on the surfactant concentration of the system. Nanoemulsions (50-1000 nm) of monomers, and any incorporated additives can be efficiently made this way, typically only needing 1-10 wt % surfactant to monomer.

In a more embodiment, step (iii) of mixing is carried out at a temperature of 30° C. to 80° C.

In a most preferred embodiment, step (iii) of mixing is carried out at a temperature of 40° C. to 80° C.

In a preferred embodiment, the nanoemulsion has an average particle size in the range of 50 nm to 800 nm determined according to dynamic light scattering technique.

In a more preferred embodiment, the nanoemulsion has an average particle size in the range of 50 nm to 700 nm determined according to dynamic light scattering technique.

In a most preferred embodiment, the nanoemulsion has an average particle size in the range of 50 nm to 650 nm determined according to dynamic light scattering technique.

Dynamic light scattering (DLS) is a common technique used to determine the size distribution of dispersed nanoparticles. DLS utilizes temporal fluctuations in light scattered by nanoparticles to calculate a distribution of translational diffusion coefficients, which is then converted to a distribution of apparent hydrodynamic diameters. The nanoemulsion or polymer (latex) is diluted in DI water and then placed in the zetasizer machine. The machine emits a laser which is scattered by the particles. The software can than infer from the amount of light scattered the average particle size of the nanoemulsion or polymer (latex).

The average particle size is represented as volume average particle size distribution which physically represents that each volume of particles greater or smaller than the volume median takes account of 50% of the total particles volume.

Nanoemulsions can be obtained with low energy and unoptimized systems by using a lot of surfactant. This can be 1 g of surfactant to oil but can be as large as 10 g surfactant to oil. Applying HLD and internal phase ratios to the system allows the efficient (performance and cost) use of surfactant. Typically, a nanoemulsion using HLD and internal phase ratios will have 0.01 to 0.1 g of surfactant to monomer according to the present invention.

Joining HLD to the nanoemulsion process yields a robust, scalable process for producing the nanoemulsion required for polymerization. Due to the low energy required, the process is scalable, and using HLD allows adjustments to be predicted when changing system conditions.

In an embodiment, the step (iii) of mixing has a power density of 0.1 W/kg to 100 W/kg.

In a more preferred embodiment, the step (iii) of mixing has a power density of 0.1 W/kg to 10 W/kg.

In a most preferred embodiment, the step (iii) of mixing has a power density of 0.1 W/kg to 1 W/kg.

In an embodiment, all the steps, step (i) to step (iii) of the process for preparing the nanoemulsion can be automated and computer implemented.

In an embodiment, the present invention discloses a process for preparing a nanoemulsion comprises the steps of:
(i) forming an emulsion system having a hydrophilic-lipophilic deviation (HLD) value in the range of 0 to −1 at a temperature of 0° C. to 100° C., wherein said emulsion system comprises at least one monomer, at least one surfactant, a salt and water,
(ii) increasing the internal phase of said emulsion system to up to 80% by volume by adding an additional amount of the at least one monomer used in step (i) or at least one monomer different than used in step (i) to said emulsion system, and
(iii) mixing the contents of step (ii) at a temperature of 0° C. to 100° C. to obtain a nanoemulsion having a volume average particle size in the range of 50 nm to 1000 nm determined according to dynamic light scattering technique,
wherein the step (iii) of mixing has a power density of 0.1 W/kg to 100 W/kg.

In another embodiment, the present invention discloses a process for preparing a nanoemulsion comprises the steps of:
(i) forming an emulsion system having a hydrophilic-lipophilic deviation (HLD) value in the range of 0 to −1 at a temperature of 0° C. to 100° C., wherein said emulsion system comprises at least one monomer, at least one surfactant, a salt and water,
(ii) increasing the internal phase of said emulsion system to up to 80% by volume by adding an additional amount of the at least one monomer used in step (i) or at least one monomer different than used in step (i) to said emulsion system, and
(iii) mixing the contents of step (ii) at a temperature of 0° C. to 100° C. to obtain a nanoemulsion having a volume average particle size in the range of 50 nm to 1000 nm determined according to dynamic light scattering technique,
wherein the step (iii) of mixing has a power density of 0.1 W/kg to 100 W/kg, wherein the at least one surfactant is selected from cationic surfactant, anionic surfactant, zwitterionic surfactant, non-ionic surfactant, or combinations thereof.

In another embodiment, the present invention discloses a process for preparing a nanoemulsion comprises the steps of:
(i) forming an emulsion system having a hydrophilic-lipophilic deviation (HLD) value in the range of 0 to −1 at a temperature of 0° C. to 100° C., wherein said emulsion system comprises at least one monomer, at least one surfactant, a salt and water,
(ii) increasing the internal phase of said emulsion system to up to 80% by volume by adding an additional amount of the at least one monomer used in step (i) or at least one monomer different than used in step (i) to said emulsion system, and
(iii) mixing the contents of step (ii) at a temperature of 0° C. to 100° C. to obtain a nanoemulsion having a volume average particle size in the range of 50 nm to 1000 nm determined according to dynamic light scattering technique,
wherein the step (iii) of mixing has a power density of 0.1 W/kg to 100 W/kg,
wherein the amount of salt in the emulsion system is in the range of 0.1 to 15% by weight, based on the total weight of the monomer.

In a particularly preferred embodiment, the step (i) is computer implemented.

In an embodiment, the step (i) is computer implemented comprising the steps of:
a. receiving at a computing device, input data at least selected from the parameters salinity, equivalent alkane carbon number (EACN), temperature and characteristic curvature (Cc) of surfactant,
b. adjusting the parameters of step (a) to obtain HLD value of 0 to −1 using equation (I) or (II)

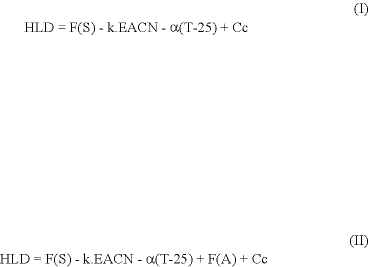

wherein
EACN Effective Alkane Carbon Number of the monomer or oil component
T temperature, in ° C.
S is a function of salinity in g/100 ml
Cc characteristic curvature of the surfactant
α temperature coefficient; and
F(A) is a function of the % Alcohol or other additional component added to the system.

By applying and solving equation (I) and/or equation (II the parameters are optimized, leading to a process which works at low energy and with less amount of surfactant.

‘Computer implemented’ or ‘computing device’, refers to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Computer implemented step (i) may be stored on a computer-readable storage medium (e.g., a non-transitory computer-readable storage medium). A computer-readable storage medium may be a floppy disk, a hard disk, a CD (compact disk), a DVD (Digital Versatile Disk), an USB (Universal Serial Bus) storage device, a RAM (Random Access Memory), a ROM (Read Only Memory) and an EPROM (Erasable Programmable Read Only Memory. The present invention can be implemented in digital electronic circuitry, or in computer hardware, firmware, software, or in combinations thereof, e.g. in available hardware of conventional mobile devices.

Equations (I) and (II) are known to a person skilled in the art and are disclosed in prior art such as journal article, J Surfact Deterg (2013) 16:449-472.

In another aspect, the present invention discloses a process for preparing a polymer from a nanoemulsion, comprising the steps of
(I) charging the nanoemulsion obtained by the process as described herein above, into a reactor,
(II) adding at least one initiator to step (I), and
(III) mixing the contents of step (II) to obtain a polymer having a volume average particle size in the range of 50 nm to 1000 nm, determined according to dynamic light scattering technique.

As used herein, the term “polymer” generally denotes a molecule having at least four monomer units. It includes, but is not limited to, homopolymers, copolymers, such as for example, block, graft, random and alternating co-polymers. Furthermore, unless otherwise specifically limited, the term “polymer” shall include all possible isomeric configurations of the monomers, including, but are not limited to isotactic, syndiotactic and random symmetries configurations, and combinations thereof. Furthermore, unless otherwise specifically limited, the term “polymer” shall include all possible geometrical configurations of the molecule.

In this process, the nanoemulsion is polymerized, for example through free radical polymerization, to produce an aqueous polymer dispersion. Each monomer nanodroplet is converted to a polymer nanoparticle, with the surfactant remaining at the interface of the particles and continuous phase, stabilizing against coagulation. Any additives incorporated in the monomer nanodroplets will therefore remain in the polymer nanoparticles and be evenly incorporated throughout the final polymer when dried, e.g. as a coating or adhesive.

Traditional emulsion polymerization depends upon a mechanism where the monomer transports from the emulsion droplet through the aqueous phase into a growing latex particle.

When using monomers with low solubility, or additives (wax, nanoparticles) they will not take part in this process. The reaction will either stall (hydrophobic monomers) or the additive won't be carried through the water into the latex/polymer (additives).

Miniemulsion polymerization works through polymerizing the emulsion droplet directly. This is traditionally accomplished through reducing the size of the emulsion.

In an embodiment, the process of preparing the polymer of the presently claimed invention comprises at least one polymerization initiator. The at least one polymerization initiator suitable for carrying out the process may thermally decompose into radicals in a first order reaction.

In an embodiment, the initiator is oil-soluble or water-soluble initiator selected from a peroxide, persulfate, azo compound, or mixtures thereof.

In an embodiment, the at least one oil-soluble initiator is selected from the group consisting of 2,2′-azodi-(2,4-dimethylvaleronitrile), 2,2′-azobisisobutyronitrile (AIBN), 2,2′-azobis(2-methylbutyronitrile), 1,1′-azobis (cyclohexane-1-carbonitrile), tertiary butylperbenzoate, tert-amyl peroxy 2-ethylhexyl carbonate, 1,1-bis(tert-amyl peroxy) cyclohexane, lauryl peroxide, di-tert-butyl peroxide, di-tert amyl peroxide, benzoyl peroxide, or mixtures thereof,

In an embodiment, the at least one water-soluble initiator is selected from succinic acid peroxide, tertbutyl hydroperoxide (TBHP), ammonium persulfate, sodium persulfate, potassium persulfate or mixtures thereof.

In an embodiment, the initiator may be added during the process of preparing nanoemulsions or during the process of preparing polymer from the said nanoemulsion. Preferably, the oil soluble initiator is added to the nanoemulsion whereas the water-soluble initiator is added during the process of preparing the polymer.

In a preferred embodiment, the initiator is a water-soluble initiator selected from tertbutyl hydroperoxide (TBHP), ammonium persulfate, or mixtures thereof.

In a preferred embodiment, step (III) is carried out at a temperature of 30 to 100° C.

In a preferred embodiment, the polymer has an average particle size in the range of 50 nm to 800 nm determined according to dynamic light scattering technique.

In a more preferred embodiment, the polymer has an average particle size in the range of 50 nm to 700 nm determined according to dynamic light scattering technique.

In a most preferred embodiment, the polymer has an average particle size in the range of 50 nm to 650 nm determined according to dynamic light scattering technique.

### Advantages

The instant invention offers one or more of the following advantages
1. The nanoemulsification process is scalable, while maintaining a low surfactant loading level.
2. The process is cost effective and avoids undesirable latex characteristics downstream.
3. The process according to the present invention fits within existing industrial equipment used for traditional emulsion polymerization.
4. Due to the process according to the present invention, the final particle size of the polymer/latex can be controlled, the final size should be the same as the initial emulsion size, not so in traditional emulsion polymerization.
5. The process enables the use of hydrophobic monomers, allowing new polymer/latex properties like glass transition temperature.
6. The process according to the present invention facilitates the addition of functional additives to the nanoemulsion that are then incorporated into the polymer/latex and thus improve the functional properties of the polymer. For example: adding a wax to the nanoemulsion, and therefore polymer, would make the product water resistance. A number of functional additives can be incorporated through this process.
7. The process can be automated and optimized by using a computer device.
8. Due to automation and computer implementation, the whole process becomes easy.

### EMBODIMENTS

The present invention is illustrated in more detail by the following embodiments and combinations of embodiments which result from the corresponding dependency references and links:

1. A process for preparing a nanoemulsion comprising the steps of:
(i) forming an emulsion system having a hydrophilic-lipophilic deviation (HLD) value in the range of 0 to −1 at a temperature of 0° C. to 100° C., wherein said emulsion system comprises at least one monomer, at least one surfactant, a salt and water,
(ii) increasing the internal phase of said emulsion system to up to 80% by volume by adding an additional amount of the at least one monomer used in step (i) or at least one monomer different than used in step (i) to said emulsion system, and
(iii) mixing the contents of step (ii) at a temperature of 0° C. to 100° C. to obtain a nanoemulsion having a volume average particle size in the range of 50 nm to 1000 nm determined according to dynamic light scattering technique.

2. The process according to embodiment 1, wherein the step (iii) of mixing has a power density of 0.1 W/kg to 100 W/kg.

3. The process according to embodiment 1 or 2, wherein the step (iii) of mixing has a power density of 0.1 W/kg to 10 W/kg.

4. The process according to embodiment 1, wherein the at least one monomer is a hydrophobic monomer.

5. The process according to embodiment 4, wherein the hydrophobic monomer is α,β-ethylenically unsaturated monomer.

6. The process according to embodiment 4 or 5, wherein the at least one monomer is selected from methyl acrylate, methyl methacrylate, ethyl acrylate, ethyl methacrylate, n-butyl acrylate, butyl methacrylate, 2-ethylhexyl acrylate, 2-ethylhexyl methacrylate, isobutyl (meth)acrylate, n-hexyl (meth)acrylate, n-heptyl (meth)acrylate, 2-methylheptyl (meth)acrylate, octyl (meth)acrylate, isooctyl (meth)acrylate, n-nonyl (meth)acrylate, isononyl (meth)acrylate, n-decyl (meth)acrylate, isodecyl (meth)acrylate, dodecyl (meth)acrylate, lauryl acrylate, lauryl (meth)acrylate, tridecyl (meth)acrylate, stearyl acrylate, stearyl (meth)acrylate, glycidyl (meth)acrylate, alkyl crotonates, di-n-butyl maleate, di-octylmaleate, hydroxyethyl (meth)acrylate, allyl (meth)acrylate, tetrahydrofurfuryl (meth)acrylate, cyclohexyl (meth)acrylate, 2-ethoxyethyl (meth)acrylate, 2-methoxy (meth)acrylate, 2 (2 ethoxyethoxy)ethyl (meth)acrylate, 2-propylheptyl (meth)acrylate, 2-phenoxyethyl (meth)acrylate, isobornyl (meth)acrylate, caprolactone (meth)acrylate, polypropyleneglycol mono(meth)acrylate, polyethyleneglycol (meth)acrylate, benzyl (meth)acrylate, hydroxypropyl (meth)acrylate, methylpolyglycol (meth)acrylate, 3,4-epoxycyclohexylmethyl (meth)acrylate, 1,6 hexanediol di(meth)acrylate, 1,4 butanediol di(meth)acrylate, styrene, butadiene, vinyl esters, 2-ethylhexyl thioglycolate, 3,5,5-trimethyl-1-hexyl acrylate, 3-butyl mercaptopropionate, acetoacetoxyethyl methacrylate, alpha methylstyrene, C₁₇-acrylate, diacetone acrylamide, dimethylaminoethyl acrylate, isoamyl acrylate, isobutyl acrylate, isodecyl acrylate, isononyl acrylate, isoprenol acrylate, prenol acrylate, tert-butyl acrylate, tert-butyl methacrylate, acrylonitrile, (meth)acrylamide, acrylic acid, methacrylic acid, itaconic acid, crotonic acid, maleic acid, fumaric acid, dimethacrylic acid, ethylacrylic acid, allylacetic acid, vinylacetic acid, vinyllactic acid, mesaconic acid, methylenemalonic acid, citraconic acid, vinyl-sulfonic acids, styrenesulfonic acids, acrylamidomethylpropanesulfonic acid, sulfopropyl acrylate, sulfopropyl methacrylate, (meth)acrylic phosphate esters, vinyl acetate or combinations thereof.

7. The process according to one or more of embodiments 1 to 6, wherein the volume % of monomer is 20% to 80% by volume.

8. The process according to embodiment 1, wherein steps (i) to (iii) are carried out at a temperature of 20° C. to 80° C.

9. The process according to one or more of embodiments 1 to 8, wherein the amount of the at least one surfactant is in the range of 1 to 10% by weight, based on the total weight of the monomer.

10. The process according to one or more of embodiments 1 to 9, wherein the characteristic curvature value (Cc) of the at least one surfactant is in the range of −10 to 10, calculated as molar-based average of each individual surfactant.

11. The process according to one or more of embodiments 1 to 10, wherein the at least one surfactant is selected from cationic surfactant, anionic surfactant, zwitterionic surfactant, non-ionic surfactant, and combinations thereof.

12. The process according to embodiment 11, wherein the at least one surfactant is selected from alkyl sulfates, alkyl benzene sulfonates, alkyl diphenyl oxide disulfonates, alkyl sulfosuccinates, sulfosuccinate esters, alkyl sulfosuccinamates, alkyl ether sulfates, alkyl phenol polyethoxy ether sulfates, alkyl phenol alkyl ether phosphates, quaternary amines, block copolymers containing ethylene oxide, alkyl polyethoxy and/or polypropoxy ethers.

13. The process according to one or more of embodiments 1 to 12, wherein the amount of salt in the emulsion system is in the range of 0.1 to 15% by weight, based on the total weight of the monomer.

14. The process according to one or more of embodiments 1 to 12, wherein the amount of salt in the emulsion system is in the range of 0.1 to 10% by weight, based on the total weight of the monomer.

15. The process according to one or more of embodiments 1 to 12, wherein the amount of salt in the emulsion system is in the range of 0.1 to 5% by weight, based on the total weight of the monomer.

16. The process according to one or more of embodiments 1 to 15, wherein the salt is selected from sodium chloride, potassium chloride, sodium hydroxymethanesulfinate hydrate, tetrasodium pyrophosphate.

17. The process according to one or more of embodiments 1 to 16, wherein the emulsion system further comprises at least an additional component selected from oil, oil soluble compound or alcohol.

18. The process according to embodiment 1, wherein step (i) is computer implemented comprising the steps of:
a. receiving at a computing device, input data at least selected from the parameters salinity, equivalent alkane carbon number (EACN), temperature and characteristic curvature (Cc) of surfactant,
b. adjusting the parameters of step(a) to obtain HLD value of 0 to −1 using equation (I) or (II)

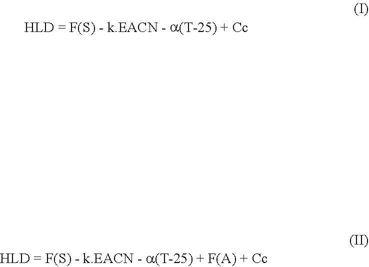

wherein
EACN Effective Alkane Carbon Number of the monomer or oil component
T temperature, in ° C.
S is a function of salinity in g/100 ml
Cc characteristic curvature of the surfactant
α temperature coefficient; and
F(A) is a function of the % Alcohol or other Additional component added to the system.

19. An aqueous nanoemulsion prepared by the process according to one or more of embodiments 1 to 18.

20. A process for preparing a polymer from a nanoemulsion, comprising the steps of
(I) charging the nanoemulsion obtained by the process according to one or more of embodiments 1 to 16 into a reactor,
(II) adding at least one initiator to step (I), and
(III) mixing the contents of step (II) to obtain a polymer having a volume average particle size in the range of 50 nm to 1000 nm, determined according to dynamic light scattering technique.

21. The process according to embodiment 20, wherein the initiator is selected from a peroxide, persulfate, azo compound, or mixtures thereof.

22. The process according to embodiment 21, wherein the initiator is selected from tertbutyl hydroperoxide (TBHP), ammonium persulfate, or mixtures thereof.

23. The process according to embodiment 20, wherein step (III) is carried out at a temperature of 30 to 100° C.

### EXAMPLES

### Compounds

### Surfactants:

The surfactants are as follows:
Surfactant 1: Na dioctylsulfosuccinate, dissolved in a mixture of water & neopentyl glycol
Surfactant 2: Anionic surfactant of following formula:

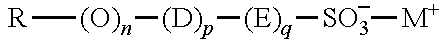

n is 1, p is in the range of 0 to 8, q is an integer in the range of 00 to 8, R is linear or branched unsubstituted or substituted C₁₀-C₁₈ alkyl or C₁₀-C₁₈ alkyl aryl, M=sodium or H.

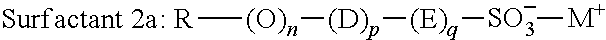

n is 1, p is in the range of 3 to 8, q is an integer in the range of 0.05 to 8, R is linear or branched, unsubstituted C₁₄-C₁₈ alkyl, M=sodium or H.

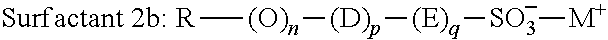

n is 0, p is 0, q is 0, R is linear or branched unsubstituted or substituted C₁₀-C₁₃ alkyl aryl M=sodium.

### Monomers:

Stearyl Acrylate
Lauryl Acrylate
2-Ethylhexyl acrylate (2-EHA)
Methyl methacrylate (MMA)
Azobisisobutyronitrile (AIBN)
Salt: Sodium chloride (NaCl)

### Oil

Hexadecane
Glissopal 1300

### Methods

### Thermal Analysis

Samples were analyzed by DSC (TA Instruments DSC2500) under N₂ using a heat/cool/heat cycle at 10° C./min. The samples were first heated from room temperature to 300 □ C and then cooled to −80° C. and reheated to 300° C. The analysis was repeated with pin-hole lids and cooled before first heat cycle.

### Dynamic Light Scattering for Particle Size Determination

Dynamic light scattering (DLS) is a common technique used to determine the size distribution of dispersed nanoparticles. DLS utilizes temporal fluctuations in light scattered by nanoparticles to calculate a distribution of translational diffusion coefficients, which is then converted to a distribution of apparent hydrodynamic diameters. The nanoemulsion or polymer (latex) is diluted in DI water and then placed in the zetasizer machine. The machine emits a laser which is scattered by the particles. The software can than infer from the amount of light scattered the average particle size of the nanoemulsion or polymer (latex).

### General Procedure

The monomer mixture comprises 13% hexadecane (oil component) and following monomers:

| Wt % | Monomer |
|---|---|
| 9% | Stearyl Acrylate |
| 27% | Lauryl Acrylate |
| 26% | 2-EHA |
| 26% | MMA |

Components in vial 1 and vial 2 are as follows:

| | | |
|---|---|---|
| Amount | Example 1 | Example 2 |

| | | | |
|---|---|---|---|
| 0.015 | g | Surfactant 1 | Surfactant 1 |
| 0.015 | g | Surfactant 2 | Surfactant 2 |
| 3 | mL | Monomer Mixture | Monomer Mixture |
| 1 | mL | NaCl solution- | NaCl solution - |
| | | salinity 13.75% | salinity 15% |

| | | |
|---|---|---|
| HLD | −0.14 | −0.05 |

The process of emulsification for each vial is as follows:

1 mL salt solution and surfactants 1 and 2 were added to vial, 3 mL of monomer mixture was added to the vial and emulsified. 2 mL of salt solution was further added and mixed once more. The particle sizes of resulting pre-emulsion were analyzed before polymerization. These vials were held in the oven for 16 hours at 80° C. The vials were cooled to room temperature and analyzed by zetasizer (Zetasizer Nano ZS90) through dynamic light scattering for final latex (polymer) particle size.

The average particle size of the pre-emulsion and the polymer is as follows:

| | Average particle size | Average particle size |
|---|---|---|
| Example | of pre-emulsion | of polymer |
| 1 | 437 nm | 323 nm |
| 2 | 364 nm | 252 nm |

Particle size analysis shows the particle size of the polymer correlates to the starting pre-emulsion size.

### DSC Results of the Polymer

| | | 1st Heat | Cool | 2nd Heat |
|---|---|---|---|---|
| sample | replicate | Tg (° C.) | Tg (° C.) | Tg (° C.) |
| Example-1 | 1 | na | −35 | −32 |
| | 2 | −28 | −36 | −29 |
| Example-2 | 1 | na | −41 | −33 |
| | 2 | −28 | −41 | −30 |

DSC data showed a single peak, thereby indicating that only one product (polymer) was formed and there was no unreacted monomer present. This also indicates that the process of the present invention works well for hydrophobic monomer as it leads to the formation of desired polymer.

### General Procedure 2

The monomer mixture comprises 10% hexadecane (oil component) and following monomers:

| Wt % | Monomer |
|---|---|
| 10% | Stearyl Acrylate |
| 29% | Lauryl Acrylate |
| 25% | 2-EHA |
| 25% | MMA |
| 1% | AIBN |

Components in vessel were as follows:

| Amount | | Example 3 | Example 4 | Example 5 | Example 6 |
|---|---|---|---|---|---|
| 5.85 | g | Surfactant 2a | Surfactant 2a | Surfactant 2a | Surfactant 2a |
| 5.85 | g | Surfactant 1 | Surfactant 1 | Surfactant 1 | Surfactant 1 |
| 300 | mL | Monomer Mixture | Monomer Mixture | Monomer Mixture | Monomer Mixture |
| 100 | mL | NaCl solution- | NaCl solution - | NaCl solution - | NaCl solution - |

| | | | | |
|---|---|---|---|---|
| | salinity 0% | salinity 0.55% | salinity 0.6% | salinity 1.5% |
| HLD | −0.95 | −0.005 | +0.05 | +0.7* |

*example not as per invention

The process of emulsification for each vessel was as follows:

Salt solution and surfactants 1 and 2 were added 500 mL round bottom flask. Monomer mixture was added to vessel dropwise while stirring at 300 rpm to emulsify. The particle sizes of resulting pre-emulsion were analyzed before polymerization. 200 g deionized water were added to a 1 L round bottom flask and heated to 85° C. under nitrogen while stirring at 300 rpm. The monomer emulsion was then pumped from the emulsion vessel to the reaction vessel over 80 minutes. The reaction was continued for an additional 2 hours. The reaction product was cooled to room temperature and analyzed by optical microscope.

The average particle size of the pre-emulsion and the polymer is as follows:

| | Average particle size | Average particle size |
|---|---|---|
| Example | of pre-emulsion | of polymer |
| 3 | 1090 nm | 273 nm |
| 4 | 644 nm | 282 nm |
| 5 | 223 nm | 179 nm |
| 6 | — | — |

Microscopy showed the particle size of the polymer correlates to the starting pre-emulsion size except for Example 6 where the initial emulsion formed was a water in oil system as evidenced by its inversion (w/o/w) upon dilution in water. The material then phase separated upon reaction.

### General Procedure 3

The monomer mixture comprises 10% Glissopal 1300 (oil component) and following monomers:

| Wt % | Monomer |
|---|---|
| 10% | Stearyl Acrylate |
| 29% | Lauryl Acrylate |
| 25% | 2-EHA |
| 25% | MMA |
| 1% | AIBN |

Components in vessel were as follows:

| | |
|---|---|
| Amount | Example 7 |

| | | |
|---|---|---|
| 3.73 | g | Surfactant 2a |
| 14.69 | g | Surfactant 1 |
| 200 | mL | Monomer Mixture |
| 100 | mL | NaCl solution- |

| | |
|---|---|
| | salinity 0.1% |
| HLD | −0.05 |

The process of emulsification for each vessel was as follows:

Salt solution and surfactants 1 and 2 were added 500 mL round bottom flask. Monomer mixture was added to vessel dropwise while stirring at 300 rpm to emulsify. The particle sizes of resulting pre-emulsion were analyzed before polymerization. 100 g deionized water were added to a 1 L round bottom flask and heated to 85° C. under nitrogen while stirring at 300 rpm. The monomer emulsion was then pumped from the emulsion vessel to the reaction vessel over 80 minutes. The reaction was continued for an additional 2 hours. The reaction product was cooled to room temperature and analyzed by zetasizer (Zetasizer Nano ZS90) through dynamic light scattering for final latex (polymer) particle size.

The average particle size of the pre-emulsion and the polymer is as follows:

| | Average particle size | Average particle size |
|---|---|---|
| Example | of pre-emulsion | of polymer |
| 7 | 219 nm | 192 nm |

### General Procedure 4

The monomer mixture comprises 10% hexadecane (oil component) and following monomers:

| Wt % | Monomer |
|---|---|
| 10% | Stearyl Acrylate |
| 29% | Lauryl Acrylate |
| 25% | 2-EHA |
| 26% | MMA |

Components in vessels were as follows:

| | |
|---|---|
| Amount | Example 8 |

| | | |
|---|---|---|
| 1.65 | g | Surfactant 2a |
| 14.66 | g | Surfactant 1 |
| 200 | mL | Monomer Mixture |
| 100 | mL | NaCl solution- |

| | |
|---|---|
| | salinity 0% |
| HLD | −0.05 |

The process of emulsification for each vessel is as follows:

Salt solution and surfactants 1 and 2 were added 500 mL round bottom flask. Monomer mixture was added to vessel dropwise while stirring at 300 rpm to emulsify. The particle sizes of resulting pre-emulsion were analyzed before polymerization. 85 g deionized water were added to a 1 L round bottom flask and heated to 85° C. under nitrogen while stirring at 300 rpm. The monomer emulsion was then pumped from the emulsion vessel to the reaction vessel over 80 minutes with a co-feed of 0.2 g potassium persulfate in 15 ml deionized water. The reaction was continued for an additional 2 hours. The reaction product was cooled to room temperature and analyzed by zetasizer (Zetasizer Nano ZS90) through dynamic light scattering for final latex (polymer) particle size.

The average particle size of the pre-emulsion and the polymer is as follows:

| | Average particle size | Average particle size |
|---|---|---|
| Example | of pre-emulsion | of polymer |
| 8 | 214 nm | 128 nm |

### General Procedure 5

The monomer mixture comprises 10% hexadecane (oil component) and following monomers:

| Wt % | Monomer |
|---|---|
| 10% | Stearyl Acrylate |
| 29% | Lauryl Acrylate |
| 25% | 2-EHA |
| 25% | MMA |
| 1% | AIBN |

Components in Vessel are as Follows:

| | | | |
|---|---|---|---|
| Amount | Example 9 | Example 10 | Example 11 |

| | | | | |
|---|---|---|---|---|
| 5.85 | g | Surfactant 2b | Surfactant 2b | Surfactant 2b |
| 5.85 | g | Surfactant 1 | Surfactant 1 | Surfactant 1 |
| 200 | mL | Monomer | Monomer | Monomer |
| | | Mixture | Mixture | Mixture |
| 100 | mL | NaCl solution- | NaCl solution - | NaCl solution - |

| | | | |
|---|---|---|---|
| | salinity 0% | salinity 0.25% | salinity 0.5% |
| HLD | −0.85 | −0.25 | +0.10* |

*example not as per invention

The process of emulsification for each vessel was as follows:

Salt solution and surfactants 1 and 2 were added 500 mL round bottom flask. Monomer mixture was added to vessel dropwise while stirring at 300 rpm to emulsify. The particle sizes of resulting pre-emulsion were analyzed before polymerization. 200 g deionized water were added to a 1 L round bottom flask and heated to 85° C. under nitrogen while stirring at 300 rpm. The monomer emulsion was then pumped from the emulsion vessel to the reaction vessel over 80 minutes. The reaction was continued for an additional 2 hours. The reaction product was cooled to room temperature and analyzed by optical microscope.

The average particle size of the pre-emulsion and the polymer is as follows:

| | Average particle size | Average particle size |
|---|---|---|
| Example | of pre-emulsion | of polymer |
| 9 | 2100 nm | 460 nm |
| 10 | 1280 nm | 490 nm |
| 11 | 560 nm | NA |

Microscopy showed the particle size of the polymer correlates to the starting pre-emulsion size in examples 9 and 10 at 0% and 0.25% NaCl respectively. At 0.5% NaCl (example 11) multi-emulsions begin to form.

1. A process for preparing a nanoemulsion comprising the steps of:
(i) forming an emulsion system having a hydrophilic-lipophilic deviation (HLD) value in the range of 0 to −1 at a temperature of 0° C. to 100° C., wherein said emulsion system comprises at least one monomer, at least one surfactant, a salt, and water,
(ii) increasing the internal phase of said emulsion system to up to 80% by volume of the emulsion system by adding an additional amount of the at least one monomer used in step (i) or at least one monomer different than used in step (i) to said emulsion system, and
(iii) mixing the contents of step (ii) at a temperature of 0° C. to 100° C. to obtain a nanoemulsion having a volume average particle size in the range of 50 nm to 1000 nm determined according to dynamic light scattering technique.

2. The process according to claim 1, wherein the step (iii) of mixing has a power density of 0.1 W/kg to 100 W/kg.

3. The process according to claim 1, wherein the step (iii) of mixing has a power density of 0.1 W/kg to 10 W/kg.

4. The process according to claim 1, wherein the at least one monomer is a hydrophobic monomer.

5. The process according to claim 4, wherein the hydrophobic monomer is α,β-ethylenically unsaturated monomer.

6. The process according to claim 1, wherein the at least one monomer is selected from the group consisting of methyl acrylate, methyl methacrylate, ethyl acrylate, ethyl methacrylate, n-butyl acrylate, butyl methacrylate, 2-ethylhexyl acrylate, 2-ethylhexyl methacrylate, isobutyl (meth)acrylate, n-hexyl (meth)acrylate, n-heptyl (meth)acrylate, 2-methylheptyl (meth)acrylate, octyl (meth)acrylate, isooctyl (meth)acrylate, n-nonyl (meth)acrylate, isononyl (meth)acrylate, n-decyl (meth)acrylate, isodecyl (meth)acrylate, dodecyl (meth)acrylate, lauryl acrylate, lauryl (meth)acrylate, tridecyl (meth)acrylate, stearyl acrylate, stearyl (meth)acrylate, glycidyl (meth)acrylate, alkyl crotonates, di-n-butyl maleate, di-octylmaleate, hydroxyethyl (meth)acrylate, allyl (meth)acrylate, tetrahydrofurfuryl (meth)acrylate, cyclohexyl (meth)acrylate, 2-ethoxyethyl (meth)acrylate, 2-methoxy (meth)acrylate, 2 (2 ethoxyethoxy)ethyl (meth)acrylate, 2-propylheptyl (meth)acrylate, 2-phenoxyethyl (meth)acrylate, isobornyl (meth)acrylate, caprolactone (meth)acrylate, polypropyleneglycol mono(meth)acrylate, polyethyleneglycol (meth)acrylate, benzyl (meth)acrylate, hydroxypropyl (meth)acrylate, methylpolyglycol (meth)acrylate, 3,4-epoxycyclohexylmethyl (meth)acrylate, 1,6 hexanediol di(meth)acrylate, 1,4 butanediol di(meth)acrylate, styrene, butadiene, vinyl esters, 2-ethylhexyl thioglycolate, 3,5,5-trimethyl-1-hexyl acrylate, 3-butyl mercaptopropionate, acetoacetoxyethyl methacrylate, alpha methylstyrene, C₁₇-acrylate, diacetone acrylamide, dimethylaminoethyl acrylate, isoamyl acrylate, isobutyl acrylate, isodecyl acrylate, isononyl acrylate, isoprenol acrylate, prenol acrylate, tert-butyl acrylate, tert-butyl methacrylate, acrylonitrile, (meth)acrylamide, acrylic acid, methacrylic acid, itaconic acid, crotonic acid, maleic acid, fumaric acid, dimethacrylic acid, ethylacrylic acid, allylacetic acid, vinylacetic acid, vinyllactic acid, mesaconic acid, methylenemalonic acid, citraconic acid, vinyl-sulfonic acids, styrenesulfonic acids, acrylamidomethylpropanesulfonic acid, sulfopropyl acrylate, sulfopropyl methacrylate, (meth)acrylic phosphate esters, vinyl acetate, and combinations thereof.

7. The process according to claim 1, wherein the volume percent of monomer is 20% to 80% by volume of the emulsion system.

8. The process according to claim 1, wherein steps (i) to (iii) are carried out at a temperature of 20° C. to 80° C.

9. The process according to claim 1, wherein the amount of the at least one surfactant is in the range of 1 to 10% by weight, based on the total weight of the monomer.

10. The process according to claim 1, wherein the at least one surfactant is selected from the group consisting of cationic surfactant, anionic surfactant, zwitterionic surfactant, non-ionic surfactant, and combinations thereof.

11. The process according to claim 1, wherein the amount of salt in the emulsion system is in the range of 0.1 to 15% by weight, based on the total weight of the monomer.

12. An aqueous nanoemulsion prepared by the process according to claim 1.

13. A process for preparing a polymer from a nanoemulsion, comprising the steps of
(I) charging the nanoemulsion obtained by the process according to claim 1 into a reactor,
(II) adding at least one initiator to step (I), and
(III) mixing the contents of step (II) to obtain a polymer having a volume average particle size in the range of 50 nm to 1000 nm, determined according to dynamic light scattering technique.

14. The process according to claim 13, wherein the initiator is selected from the group consisting of a peroxide, persulfate, azo compound, and mixtures thereof.
